(19) United States
(12) Patent Application Publication
(10) Pub. No.: US 2008/0187238 A1
(43) Pub. Date: Aug. 7, 2008

(54) Noise Reduction Method based on Diamond-Shaped Window

(76) Inventors: Chao-Ho Chen, Tai-Nan City (TW); Chao-Yu Chen, Kaohsiung County (TW)

Correspondence Address: NORTH AMERICA INTELLECTUAL PROPERTY CORPORATION, P.O. BOX 506, MERRIFIELD, VA, 22116, US

(21) Appl. No.: 11/775,847

(22) Filed: Jul. 10, 2007

(30) Foreign Application Priority Data
Feb. 5, 2007 (TW) 096104154

(51) Int. Cl. G06K 9/40

(52) U.S. Cl. 382/275

(57) ABSTRACT

Neighbor pixels having greatest similarities and correlations with a central pixel are exploited to develop a diamond-shaped window for performing a noise reduction procedure. The diamond-shaped window merely covers significant pixels required by the noise reduction procedure to improve the performances in reducing noises. Besides, a size of the diamond-shaped window is adjustable according to the noise ratio of noises hidden in the processed image. The noise reduction procedure utilizes the diamond-shaped window instead of a conventional square-shaped window to improve the performance in noise reduction, and to avoid possible picture quality losses of the original image caused by redundant pixels covered by the square-shaped window.

### BACKGROUND OF THE INVENTION

1. Field of the Invention

The present invention relates to a noise reduction method, and more particularly, to a noise reduction method based on a diamond-shaped window enveloping a central pixel and a set of neighboring pixels having greatest similarities and associations with the central pixel.

2. Description of the Prior Art

In the modern information era, image information plays an important role. However, no matter how complete functions of a camera are, no image captured by the camera is absolutely perfect. That is, each image brings noises of various degrees along. Noises of digital images are generated in procedures including image capturing, digitalization, and signal transmissions. The performance of an image sensor is limited by several factors including the environment for capturing images and the quality of sensing elements. For example, when a CCD camera captures images, luminosity and a temperature of the image sensor affect a lot in the amount of noises. Noises of images during transmission are primarily generated from affected transmission routes. For example, images transmitted through wireless networks are easily affected by lightning, electromagnetic pulses, or charged particles in the air so that erroneous transmitted images are generated.

Filtering of digital images, which is a primary technique in image processing, may be utilized for attenuating noises so as to raise a quality and a sense of reality of digital images. In many applications of calculating and analyzing images by operators, any noise in an image may result in serious consequences. Therefore, the aim of attenuating noises is not merely to enhance a visual quality of images, but also to enhance the performances in succeeding image processing including encoding, analyzing, segmenting, identifying, and explaining.

In digital images, erroneous operations of image capturing devices, defective image capturing conditions, and impulse noises in image transmissions result in erroneous pixels. Impulse noises are easily sensed with the naked eye, and bring some serious errors in image processing. Therefore, impulse noise reduction is conventionally applied on preprocesses of some image processing systems, such as image scaling. A best impulse noise filter is required to smooth dissimilar pixels in a smooth pixel region, and to preserve edge information without changing natural image information. There are various published impulse noise filtering algorithms in recent years, where the aim of the published algorithms is to preserve image qualities while filtering off impulse noises. Some typical nonlinear filters, such as median filters and weighted median filters, are capable of attenuating most impulse noises and filtering off most details of an image.

A differential rank impulse detector (DRID) was disclosed for effectively detecting impulse noises. In a conventional square-shaped window, there are large differences between the ranks of impulse noises and a central pixel. The central pixel always occupies a median rank, whereas the impulse noises occupy extreme ranks. Therefore, a simple impulse noise detector may thus be retrieved, where the simple impulse noise detector compares locations of interested pixels with a threshold. How the comparison works may be denoted as follows:

(R(X_{i,j})≦s) [symbol] (R(X_{i,j}))≧N−s+1 (1)

X_{i,j} indicates a central pixel of a conventional square-shaped window. R(X_{i,j}) indicates a rank of the pixel X_{i,j}. N indicates an amount of pixels covered in the square-shaped window. s indicates a threshold. The work is an effective method of simply determining whether an image is affected by impulse noises, however, erroneous determinations are easily retrieved also, and it is not reliable in determining whether the image is affected by impulse noises. For example, when a clear pixel is located at extremes of the square-shaped window, the clear pixel may easily be regarded as an affected pixel. For overcoming such defects, both gray scales and ranks of pixels are required to be taken into considerations. Therefore, the equation (1) may be evolved as:

(R(X_{i,j})≦s) [symbol] (R(X_{i,j})≧(N−s+1)) [symbol] (d_{i,j}≧θ) (2)

d_{i,j} is defined as:

$${d}_{i , j} ≡ \{ \begin{matrix}\vert {x}_{i , j} - Var [ R ( {x}_{i , j} ) - 1 ] \vert , & if R ( {x}_{i , j} ) > {MED}_{i , j} \\ \vert {x}_{i , j} - Var [ R ( {x}_{i , j} ) + 1 ] \vert , & if R ( {x}_{i , j} ) < {MED}_{i , j} \\ 0 , & else\end{matrix} \qquad ( 3 )$$

Var(k) indicates a gray scale with a rank k. The detector is designed for comparing locations and absolute values of gray scales of pixels covered by the conventional square-shaped window. Therefore, an effective and rapid technique, which has no smooth image and may be applied on any filters, is provided.

A conditional signal-adaptive median filter (CSAM), which is a determination-based median filter, indicates a method of filtering noises, where the method utilizes two functions for making determinations. The first function is utilized for determining whether there are noises enveloped by a conventional square-shaped window. The second function is utilized for smoothing pixels having noises. The algorithm of the method includes steps as follows:

Step 1: Determine an upper bound and a lower bound of a same region.

Step 2: Detect impulse noises.

Step 3: Refine chosen impulse noises.

Step 4: Filter off noises with the median filter.

In Step 2, a conventional square-shaped window having a size of 3 by 3 is provided. A central pixel has a value x₀. Each of eight neighboring pixels has a value xᵢ|ᵢ₌₁⁸. cₕ indicates an amount of pixels from the eight neighboring pixels being iso-qualitative with the central pixel, where cᵢ indicates an amount of pixels from the eight neighboring pixels being not iso-qualitative with the central pixel. When cₕ>cᵢ is satisfied, the central pixel is determined to be a signal. When cₕ<cᵢ is satisfied, the central pixel is regarded as a noise candidate.

In Step 3, for reducing erroneous determinations, various filtering methods are applied for removing clean pixels from noise candidates. Most erroneously-determined pixels lie near edges or details in an image. The erroneously-determined pixels are classified into two groups, where a first group has similar qualities with the central pixel whereas a second group does not have similar qualities with the central pixel. When the first group is larger than the second group, the central pixel is determined to be a signal and is removed from the noise candidates. Step 3 is repeatedly executed until the number of noise candidates ceases decreasing.

In Step 4, when there are less than 3 pixels similar with the central pixel and covered by the 3-by-3 square-shaped median filter, a 3-by-3 median filter is utilized for filtering off noises, else, a 5-by-5 median filter is utilized for filtering off noises. The aim of the method is for implementing close-to-perfect impulse noise detections, and for retrieving excellent visual qualities after restoring.

In a truncation filter, a pixel (i, j) is assumed to have a gray scale x(i, j), and there are N conventional M-by-M square-shaped windows covering the pixel (i, j). A window of this type is called an internal window and denoted as WIₖ. For each internal window, there is a corresponding external window WOₖ, which has a size of (M+2r)×(M+2r) with r≧1. The external window is defined to cover a same central pixel as the corresponding internal window. Therefore, there are N closed surrounding belts Bₖ, where the value of k ranges from 1 to N, and the thickness of the belt is r. The closed surrounding belt is defined as:

Bₖ=WOₖ−WIₖ (4)

uₖ indicates a largest gray scale in a closed surrounding belt, whereas vₖ indicates a smallest gray scale in a same closed surrounding belt. Both the gray scales are utilized for determining whether a pixel is affected by noises. The disclosed truncation filter is capable of preserving image details while attenuating noises.

In an adaptive two-pass median filter (ATPMF), when a noise ratio is high, the filter, such as a median filter, may not be utilized for retrieving satisfying results. Better results may be retrieved by utilizing the same filter twice, where the two-pass manner lies. First, the algorithm may be utilized for filtering off more noises than conventional sequential filters under a high noise ratio. Second, an estimated distribution of impulse noises may be utilized for correcting errors in a preceding filtering operation. The method includes following steps:

Step 10: Filter off noises with a median filter, and retrieve an estimated distribution of impulse noises.

Step 20: Determine over-adjusted pixels, and replace the pixels with original pixels.

Step 30: Filter off noises with the median filter again.

The method is utilized for reducing affects of impulse noises under a high noise ratio, and may be utilized on any sequential filters.

As can be observed, there are several algorithms reported in the prior art for attenuating noises in images. However, the disclosed algorithms are all based on conventional square-shaped windows, which may cover unnecessary pixels. Therefore in such conventional noise attenuating processes, many original qualities in an image cannot be preserved well, and the efficiency in attenuating noises is thus retarded as well. In summary, in the conventional algorithms for attenuating noises in images, image qualities may be affected, or the processing efficiency is lowered as well.

### SUMMARY OF THE INVENTION

Some concepts of the present invention have already been published in the proceedings of conference, as described below: Thou-Ho (Chao-Ho) Chen, Chao-Yu Chen, Tsong-Yi Chen, and Da-Jinn Wang, “An Impulse Noise Reduction Method by Adaptive Pixel-Correlation”, 2006 International Conference on Innovative Computing, Information and Control (ICICIC-06), Beijing, P.R. China, Aug. 30-Sep. 1, 2006, pp. 257-260.

The claimed invention discloses a noise reduction method based on a diamond-shaped window enveloping a central pixel and a set of neighboring pixels. The noise reduction method comprises shifting the diamond-shaped window to cover a first to-be-processed region on an image; calculating an average value of a plurality of pixels on the covered first to-be-processed region; arranging the plurality of pixels on the first to-be-processed region according to values of said plurality of pixels when a difference between the calculated average value and a value of the central pixel on the first to-be-processed region is larger than a predetermined value; choosing a value of a pixel, which has a specific rank in the arranged plurality of pixels, as a first filter's output; and replacing the value of the central pixel on the first to-be-processed region with the first filter's output.

The claimed invention also discloses a noise reduction method based on a diamond-shaped window enveloping a central pixel and a set of neighboring pixels. The noise reduction method comprises shifting the diamond-shaped window to cover a first to-be-processed region on an image; calculating an average value of a plurality of pixels on the covered first to-be-processed region; and preserving a value of a central pixel on the first to-be-processed region when a difference between the calculated value and the value of the central pixel is not larger than a predetermined value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a 5-by-5 square-shaped window processed in the noise reduction method of the present invention.

FIG. 2 is a statistic table of associations between the central pixel and other neighboring pixels according to FIG. 1.

FIG. 3 is a statistic table of associations between the central pixel and other neighboring pixels according to FIG. 1 while 20% of random gray scale impulse noises are mixed.

FIG. 4 is a diagram of transforming a conventional 3-by-3 square-shaped window into a diamond-shaped window according to the noise reduction method of the present invention.

FIG. 5 is a diagram of transforming a conventional 5-by-5 square-shaped window into a diamond-shaped window according to the noise reduction method of the present invention.

FIG. 6 is a diagram of transforming a conventional 7-by-7 square-shaped window into a diamond-shaped window according to the noise reduction method of the present invention.

FIG. 7 is a flowchart of the noise reduction method utilizing a diamond-shaped window according to a preferred embodiment of the present invention.

FIG. 8 is a diagram of an embodiment of the present invention according to the diamond-shaped widow shown in FIG. 4 and the procedure shown in FIG. 7.

FIG. 9 is a diagram of an embodiment of the present invention according to the diamond-shaped window shown in FIG. 5 and the procedure shown in FIG. 7.

FIG. 10 is a diagram of a weight set corresponding to the diamond-shaped window shown in FIG. 9.

FIG. 11 is the experimental result in terms of peak signal-to-noise ratio and execution time while comparing the conventional 3-by-3 square-shaped window and the diamond-shaped window shown in FIG. 4 on the Lena image and Boats image with a noise ratio ranging from 5% to 20%.

FIG. 12 is the experimental result in terms of peak signal-to-noise ratio and execution time while comparing the conventional 5-by-5 square-shaped window and the diamond-shaped window shown in FIG. 5 on the Lena image and Boats image with a noise ratio ranging from 25% to 40%.

### DETAILED DESCRIPTION

Each pixel in a digital image is associated with its neighboring pixels more or less. In an n-by-n window, the associations between pixels are defined as:

$${LC}_{ik} = \{ \begin{matrix}1 , \vert {x}_{0} - {x}_{k} \vert < T \\ 0 , otherwise\end{matrix} , 1 \leq k \leq {n}^{2} - 1 and 1 \leq i \leq N \qquad ( 5 )$$

Equation (5) defines the association between each pixel and its neighboring pixels. x₀ indicates a central pixel in a window. xₖ indicates an other pixel in the same region, i.e., a neighboring pixel of the central pixel x₀. N indicates the number of pixels in the region. T indicates a user-defined threshold. When LCᵢₖ=1 is satisfied, there are associations between the pixels x₀ and xₖ. Otherwise, when LCᵢₖ=0 is satisfied, there are no associations between the pixels x₀ and xₖ.

A cumulative pixel association may be derived by dividing a sum of respective associations by the number of pixels in the region. The process of deriving the cumulative pixel association may be listed as:

$${GC}_{k} = \frac{1}{N} {\sum }_{i = 1}^{N} {LC}_{ik} , 1 \leq k \leq {n}^{2} - 1 and 1 \leq i \leq N \qquad ( 6 )$$

The value of GCₖ ranges from 0 to 1, i.e., between 0% and 100%. The larger the value of GCₖ is, the higher association between the pixels x₀ and xₖ.

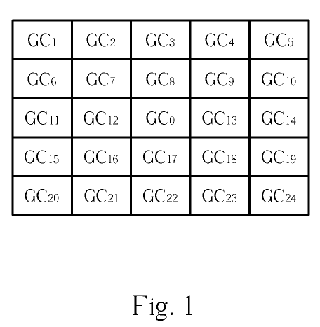

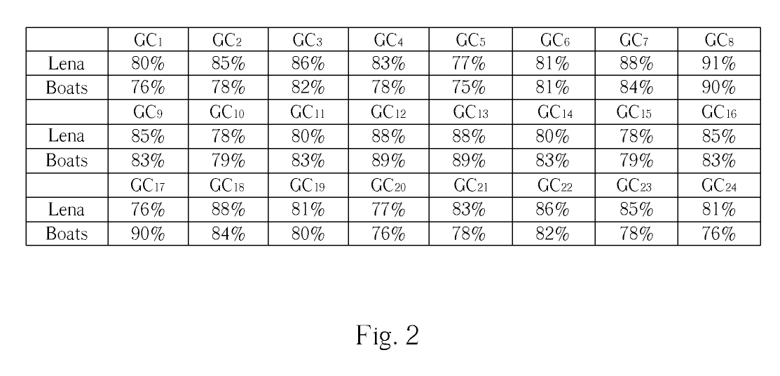

Two different test images are utilized in related experiments of the present invention, where the test images are named as a Lena image and a Boats image. Please refer to FIG. 1, which is a diagram of a 5-by-5 square-shaped window processed in the noise reduction method of the present invention. The 5-by-5 window covers a central pixel and 24 neighboring pixels. In FIG. 1, the value of the threshold T is set to 15. Then the associations between the central pixel GC₀ and other neighboring pixels from GC₁ to GC₂₄ are calculated. Please refer to FIG. 2, which is a statistic table of associations between the central pixel and other neighboring pixels according to FIG. 1. As shown in FIG. 2, pixels including GC₈, GC₁₂, GC₁₃, and GC₁₇ indicate higher associations with the central pixel GC₀. It indicates a fact that the closer to the central pixel a neighboring pixel is, the higher the corresponding association is. In other words, the farther to the central pixel a neighboring pixel is, the lower the corresponding association is. For example, pixels including GC₁, GC₅, GC₂₀, and GC₂₄ indicate lower associations with the central pixel GC₀.

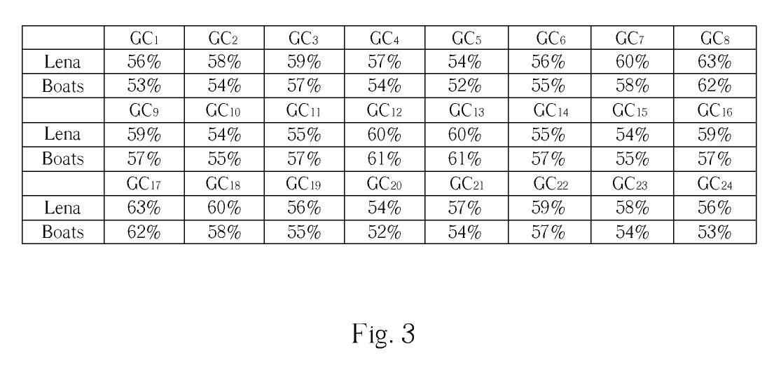

Therefore in the related experiments on both the Lena image and the Boats image, 20% of random gray scale impulse noises are mixed, and the calculations related to FIG. 1 are performed for further generating another two corresponding test images. In the experiment related to the 20% of random gray scale impulse noises, the 5-by-5 window utilized in FIG. 1 is still utilized, and the threshold T is still set to 15 for performing the same calculations. Please refer to FIG. 3, which is a statistic table of associations between the central pixel and other neighboring pixels according to FIG. 1 while 20% of random gray scale impulse noises are mixed. As shown in FIG. 3, the associations are all decreased, however, the pixels closer to the central pixel still have higher associations with the central pixel, whereas the pixels farther to the central pixel have lower associations with the central pixel. It indicates a same distribution in associations with respect to FIG. 2.

According to the analyses shown in FIG. 2 and FIG. 3, a diamond-shaped window is disclosed in the present invention and is developed based on similarities and associations. The diamond-shaped window is utilized for replacing the conventional square-shaped windows, and for performing noise attenuation with median filters, which are most common sequential filters. Primary steps in the noise reduction method of the present invention include arranging pixels covered by the diamond-shaped window according to values of the pixels, and selecting a median among the arranged pixels as a filter intermediate. In other embodiments of the present invention, a pixel having a specific rank among the arranged pixels may also be assigned as the filter intermediate. In still other embodiments of the present invention, a weighted median filter is utilized. The weighted median filter multiplies each pixel covered by the diamond-shaped window with a corresponding weight, arranges the multiplied pixels according to values of the pixels, and selects a pixel having the median value or having the specific rank as the filter intermediate.

When the pixel having the median value is assigned as the filter intermediate, the pixel may be denoted as:

Y≡median{xᵢ|xᵢεW} (7)

xᵢ indicates the i-th pixel covered by the diamond-shaped window. Y indicates the pixel having the median value. The median filter shows a great noise attenuation capability for certain random noises, and generates clearer images than other linear smooth filters. Moreover, the median filter especially works when both odd and even impulse noises appear. For example, when all pixels covered by the diamond-shaped window contain at least one impulse noise, as long as a number of the at least one impulse noise is less than half of the pixels covered by the diamond-shaped window, the assigned filter intermediate may be significantly precise, whereas other filter intermediates assigned by other linear smooth filters are highly affected by such impulse noises.

Besides, the filter intermediate is assigned as one of the pixels covered by the diamond-shaped window other than a newly-calculated pixel. In other words, when it comes to other linear smooth filters generating newly-calculated pixels, unexpected results may happen in the assigned filter intermediate.

Therefore, most noise attenuation algorithms are invented based on the median filter. In succeeding descriptions about the noise reduction method of the present invention, the median filter is primarily utilized on the diamond-shaped window for filtering off impulse noises. Noises of different ratios are also added in test images for proving the effectiveness of the noise reduction method of the present invention.

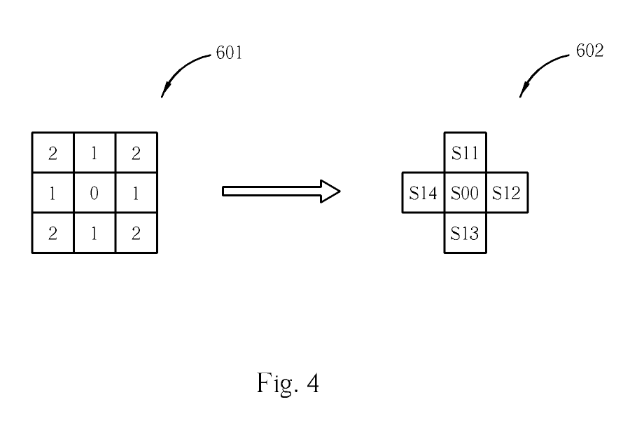

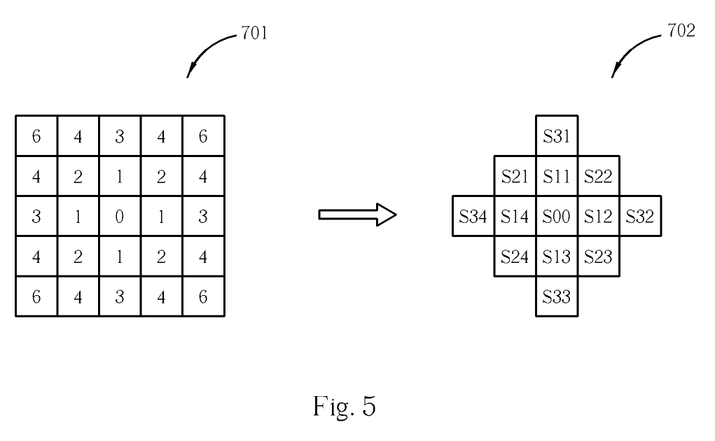

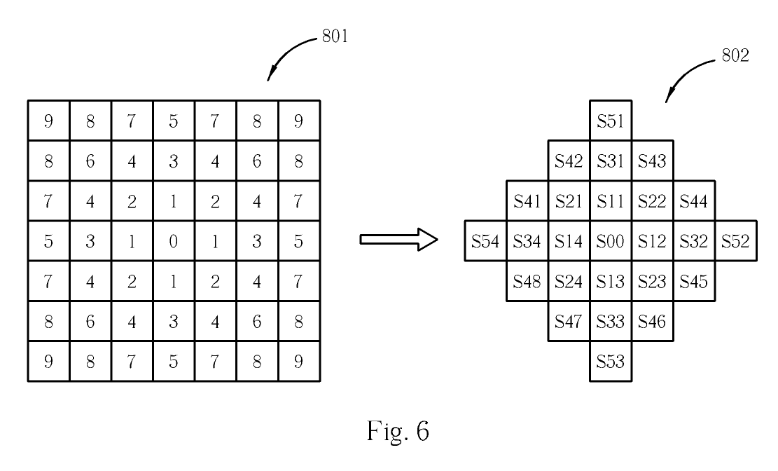

Please refer to FIG. 4, FIG. 5, and FIG. 6. FIG. 4 is a diagram of transforming a conventional 3-by-3 square-shaped window 601 into a diamond-shaped window 602 according to the noise reduction method of the present invention. FIG. 5 is a diagram of transforming a conventional 5-by-5 square-shaped window 701 into a diamond-shaped window 702 according to the noise reduction method of the present invention. FIG. 6 is a diagram of transforming a conventional 7-by-7 square-shaped window 801 into a diamond-shaped window 802 according to the noise reduction method of the present invention.

In the noise reduction method of the present invention, pixels neighboring to the central pixel may be classified into a first neighboring pixel set, a second neighboring pixel set, a third neighboring pixel set, a fourth neighboring pixel set, a fifth neighboring pixel set, and so on, according to respective distances from the central pixel. That is, the pixels are classified according to respective associations with the central pixel.

In the conventional 3-by-3 square-shaped window 601 shown in FIG. 4, the first neighboring pixel set includes the four pixels denoted by “1”. Similarly, the second neighboring pixel set includes the four pixels denoted by “2”. The central pixel is denoted by “0”. During the transformation, the second neighboring pixel set is removed from the 3-by-3 square-shaped window 601. That is, in the generated diamond-shaped window 602, merely the central pixel and the first neighboring pixel set are reserved.

In the diamond-shaped window 602, the four pixels in the first neighboring pixel set are denoted as S11, S12, S13, and S14 in clockwise order, whereas the central pixel is denoted as S00. As shown in FIG. 4, the number of processed pixels is decreased from 9 to 5. Moreover, the weighed median filter may be further utilized for decreasing processed pixels to a less amount. Therefore, time for arranging the pixels and selecting the filter intermediate is significantly decreased for raising the efficiency of noise attenuation, and for preventing the effect of edge pixels having low associations with the central pixel.

In the conventional 5-by-5 square-shaped window 701, the first neighboring pixel set includes the four pixels denoted by “1”. The second neighboring pixel set includes the four pixels denoted by “2”. The third neighboring pixel set includes the four pixels denoted by “3”. The fourth neighboring pixel set includes the eight pixels denoted by “4”. The sixth neighboring pixel set includes the four pixels denoted by “6”. The central pixel is denoted by “0”. During the transformation, the eight pixels in the fourth neighboring pixel set and the four pixels in the sixth neighboring pixel set are removed from the 5-by-5 square-shaped window 701. That is, in the generated diamond-shaped window 702, merely the four pixels in the first neighboring pixel set, the four pixels in the second neighboring pixel set, the four pixels in the third neighboring pixel set, and the central pixel are reserved.

The pixels in the diamond-shaped window 702 are denoted in a similar manner with in FIG. 4, so how the pixels in the diamond-shaped window 702 and overlapped with the diamond-shaped window 602 are denoted is not further described. The four pixels in the second neighboring pixel set are denoted as S21, S22, S23, and S24 in clockwise order. The four pixels in the third neighboring pixel set are denoted as S31, S32, S33, and S34 in clockwise order. In other words, in FIG. 5, the number of processed pixels is decreased from 25 to 13. Similarly, when the weighted median filter is further utilized, the number of processed pixels may be decreased further. Therefore, time for arranging the pixels and selecting the filter intermediate is significantly decreased for raising the efficiency of noise attenuation, and for preventing the effect of edge pixels having low associations with the central pixel.

In the conventional 7-by-7 square-shaped window 801, the first neighboring pixel set includes the four pixels denoted by “1”. The second neighboring pixel set includes the four pixels denoted by “2”. The third neighboring pixel set includes the four pixels denoted by “3”. The fourth neighboring pixel set includes the eight pixels denoted by “4”. The fifth neighboring pixel set includes the four pixels denoted by “5”. The sixth neighboring pixel set includes the four pixels denoted by “6”. The seventh neighboring pixel set includes the eight pixels denoted by “7”. The eighth neighboring pixel set includes the right pixels denoted by “8”. The ninth neighboring pixel set includes the four pixels denoted by “9”. The central pixel is denoted by “0”. During the transformation, the four pixels in the sixth neighboring pixel set, the eight pixels in the seventh neighboring pixel set, the eight pixels in the eighth neighboring pixel set, and the four pixels in the ninth neighboring pixel set are removed from the conventional 7-by-7 square-shaped window 801. That is, the four pixels in the first neighboring pixel set, the four pixels in the second neighboring pixel set, the four pixels in the third neighboring pixel set, the eight pixels in the fourth neighboring pixel set, the four pixels in the fifth neighboring pixel set, and the central pixel are reserved for generating the diamond-shaped window 802.

How the four pixels in the first neighboring pixel set, the four pixels in the second neighboring pixel set, the four pixels in the third neighboring pixel set, and the central pixel are denoted is the same as in FIG. 5, and thus are not described further. The eight pixels in the fourth neighboring pixel set are denoted as S41, S42, S43, S44, S45, S46, S47, and S48 in clockwise order. The four pixels in the fifth neighboring pixel set are denoted as S51, S52, S53, and S54 in clockwise order. In other words, as shown in FIG. 6, the number of processed pixels is decreased from 49 to 25. When the weighted median filter is further used, the number of processed pixels may be decreased further. Therefore, time for arranging the pixels and selecting the filter intermediate is significantly decreased for raising the efficiency of noise attenuation, and for preventing the effect of edge pixels having low associations with the central pixel.

Diamond-shaped windows having larger sizes according to embodiments of the present invention may be inducted from the illustrated diamond-shaped windows in FIG. 4, FIG. 5, and FIG. 6. Therefore, the size of the diamond-shaped window may be adjusted with the median filter according to the amount of noises.

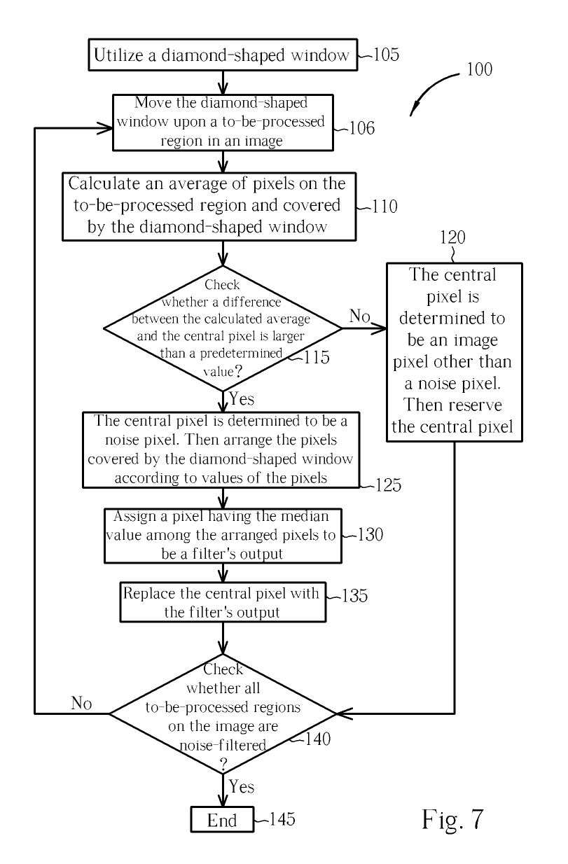

Please refer to FIG. 7, which is a flowchart of the noise reduction method utilizing a diamond-shaped window according to a preferred embodiment of the present invention. As shown in FIG. 7, the procedure 100 includes steps as follows:

Step 105: Utilize the diamond-shaped window 602.

Step 106: Move the diamond-shaped window 602 upon a to-be-processed region in an image.

Step 110: Calculate an average of pixels on the to-be-processed region covered by the diamond-shaped window 602.

Step 115: When a difference between the calculated average and the central pixel is larger than a predetermined value, go to Step 125. Otherwise, go to Step 120.

Step 120: The central pixel is determined to be an image pixel other than a noise pixel. Then reserve the central pixel, and go to Step 140.

Step 125: The central pixel is determined to be a noise pixel. Then arrange the pixels covered by the diamond-shaped window 602 according to values of the pixels.

Step 130: Assign a pixel having the median value among the arranged pixels to be the filter's output.

Step 135: Replace the central pixel with the filter's output.

Step 140: When all to-be-processed regions on the image are noise-filtered, go to Step 145. Otherwise, go to Step 106.

Step 145: End.

In Step 105, the size of the diamond-shaped window may be adjusted according to the noise ratio in the image. In other words, in Step 105, the diamond-shaped windows 702 and 802, or other larger diamond-shaped windows, may be utilized for performing Step 105.

In Step 110, an average of pixels on the to-be-processed region covered by the diamond-shaped window 602 is calculated. When the to-be-processed region is located at a northwest corner of the image, pixels covered by the diamond-shaped window 602 include the pixels S00, S12, and S13. When the to-be-processed region is located at a northeast corner of the image, pixels covered by the diamond-shaped window 602 include the pixels S00, S13, and S14. When the to-be-processed region is located at the southwest corner of the image, the pixels covered by the diamond-shaped window 602 include the pixels S00, S11, and S12. When the to-be-processed region is located at the southeast corner of the image, the pixels covered by the diamond-shaped window 602 include the pixels S00, S11, and S14. When the to-be-processed region is located at an upper edge region of the image, the pixels covered by the diamond-shaped window 602 include the pixels S00, S12, S13, and S14. When the to-be-processed region is located at a lower edge region of the image, the pixels covered by the diamond-shaped window 602 include the pixels S00, S11, S12, and S14. When the to-be-processed region is located at the right edge region of the image, pixels covered by the diamond-shaped window 602 include the pixels S00, S11, S13, and S14. When the to-be-processed region is located at the left edge region of the image, the pixels covered by the diamond-shaped region include the pixels S00, S11, S12, and S13. When the to-be-processed region is not located at any corners or any regions, the pixels covered by the diamond-shaped window 602 include the pixels S00, S11, S12, S13, and S14.

When a larger diamond-shaped window is utilized, the to-be-processed region may also be processed as mentioned with the diamond-shaped window 602. That is, pixels external to the image are not covered by the utilized diamond-shaped window. For example, when the diamond-shaped window 702 shown in FIG. 5 is utilized, and when the to-be-processed region is located at a northwest corner of the image, the pixels covered by the diamond-shaped window 702 include the pixels S00, S12, S13, S23, S32, and S33. When the diamond-shaped window 802 shown in FIG. 6 is utilized, and when the to-be-processed region is located at the southeast corner of the image, the pixels covered by the diamond-shaped window 802 include the pixels S00, S11, S14, S21, S31, S41, S42, and S54. Other embodiments of the present invention may be inducted according to the abovementioned descriptions, and are not described further.

In Step 125, pixels covered by the diamond-shaped window 602 may be multiplied by a weight before all the covered pixels along with the multiplied pixels are arranged according to values of the pixels. Besides, when the to-be-processed region is located at a corner region or an edge region of the image, pixels, except for the pixels external to the image, covered by the diamond-shaped window 602 are multiplied by a weight. Then the weighted pixels are arranged according to values of the weighted pixels.

In Step 130, the filter's output may be selected as value of the pixel having the median value among the arranged pixels, or as the value of the pixel having a specific rank among the arranged pixels.

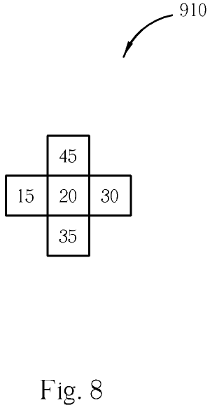

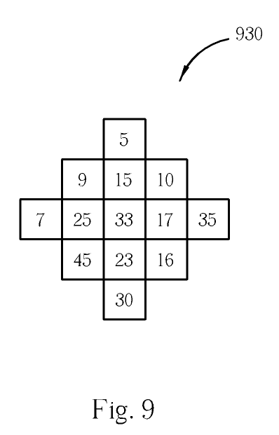

Please refer to FIG. 8, which is a diagram of an embodiment of the present invention according to the diamond-shaped widow 602 shown in FIG. 4 and the procedure 100 shown in FIG. 7. When the to-be-processed region is located at an internal region of the image, values of the pixels covered by the diamond-shaped window 602 are shown as enveloped by a diamond-shaped window 910 in FIG. 8. As shown in FIG. 8, the value of the central pixel is 20. Values of the four pixels in the first neighboring pixel set are 45, 30, 35, and 15 in clockwise order. Therefore, the average in the diamond-shaped window 910 is 29. Assume the predetermined value is 10, then the difference between the average and the central pixel is 9, which is smaller than the predetermined value. Therefore, the central pixel may be determined to be an image pixel other than a noise pixel, and is reserved. Please refer to FIG. 9, which is a diagram of an embodiment of the present invention according to the diamond-shaped window 702 shown in FIG. 5 and the procedure 100 shown in FIG. 7. When the to-be-processed region is internal to the image, values of the pixels covered by the diamond-shaped window 702 are shown as enveloped by the diamond-shaped window 930 in FIG. 9. As shown in FIG. 9, the value of the central pixel is 33. Values of the four pixels in the first neighboring pixel set are 15, 17, 23, and 25 in clockwise order. Values of the pixels of the second neighboring pixel set are 9, 10, 16, and 45 in clockwise order. Values of the four pixels in the third neighboring pixel set are 5, 35, 30, and 7 in clockwise order. Therefore, the average in the diamond-shaped window 930 is 10. Assume the predetermined value is 10, then the difference between the central pixel and the average is 13, which is larger than the predetermined value, so that the central pixel is determined to be a noise pixel. The values of the pixels covered by the diamond-shaped window 930 are arranged as 5, 7, 9, 10, 15, 16, 17, 23, 25, 30, 33, 35, and 45 in ascending order. As inducted, the median value among the arranged pixels is 17, and the value of the central pixel is thus replaced by 17.

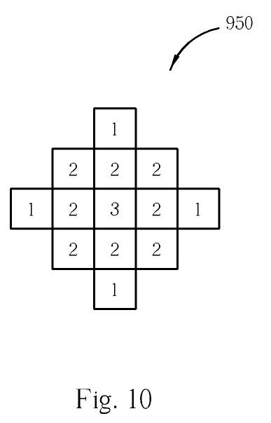

FIG. 10 illustrates an embodiment of the present invention related to weighted pixels according to the diamond-shaped window 930 shown in FIG. 9 and the procedure 100 shown in FIG. 7. FIG. 10 is a diagram of a weight set 950 corresponding to the diamond-shaped window 930 shown in FIG. 9. As illustrated in the weight set 950, since the central pixel should be multiplied by 3, i.e., two additional central pixels should be generated. Similarly, the four pixels in the first neighboring pixel set should be multiplied by 2, i.e., one additional pixel should be generated. The four pixels in the second neighboring pixel set should be multiplied by 2, i.e., one additional pixel should be generated. The four pixels in the third neighboring pixel set should be multiplied by 1, i.e., no additional pixel should be generated.

Values of the weighted pixels should be arranged as 5, 7, 9, 9, 10, 10, 15, 15, 16, 16, 17, 17, 23, 23, 25, 25, 30, 33, 33, 33, 35, 45, and 45 in ascending order. Therefore, the median value among the arranged pixels should be 17, and the value of the central pixel should be replaced with 17. A value next to the median value may also be chosen as the filter intermediate for replacing the value of the central pixel. In the arranged pixels, the value next to the median value is 23, and the value of the central pixel may thus be replaced by 23 as well.

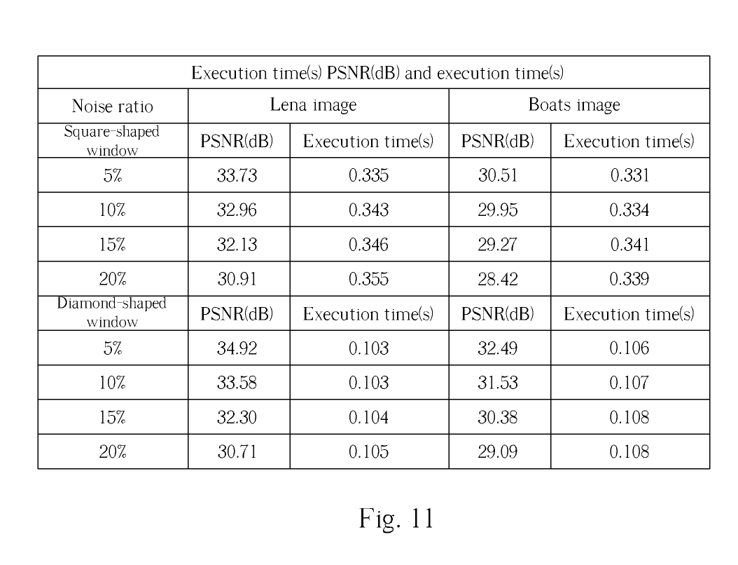

Please refer to FIG. 11, which is the experimental result in terms of peak signal-to-noise ratio and execution time while comparing the conventional 3-by-3 square-shaped window 601 and the diamond-shaped window 602 shown in FIG. 4 on the abovementioned Lena image and Boats image with a noise ratio ranging from 5% to 20%. After the noises having the noise ratio ranging from 5% to 20% are added into the images, values of the pixels of the Lena image and Boats image are uniformly distributed between 0 and 255.

As can be observed from the statistical diagram in FIG. 11, on the execution time of performing the noise attenuation, utilizing the diamond-shaped window 602 takes less than one-third of the execution time of utilizing the conventional square-shaped window 601. Besides, on the peak signal-to-noise ratio of performing the noise attenuation, utilizing the diamond-shaped window 602 results in the signal-to-noise ration being about 1 dB higher than utilizing the conventional square-shaped window 601.

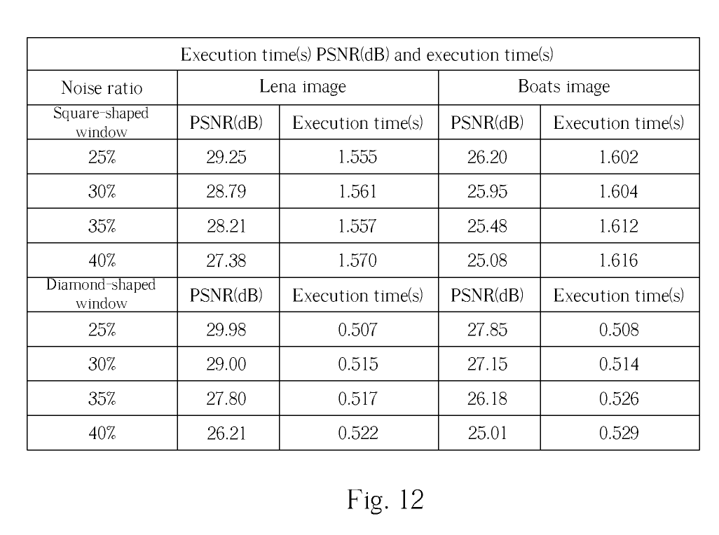

Please refer to FIG. 12, which is the experimental result in terms of peak signal-to-noise ratio and execution time while comparing the conventional 5-by-5 square-shaped window 701 and the diamond-shaped window 702 shown in FIG. 5 on the abovementioned Lena image and Boats image with a noise ratio ranging from 25% to 40%. After the noises having the noise ratio ranging from 25% to 40% are added into the images, values of the pixels of the Lena image and Boats image are uniformly distributed between 0 and 255.

As can be observed from the statistical diagram in FIG. 12, on the execution time of performing the noise attenuation, utilizing the diamond-shaped window 702 takes less than one-third of the execution time of utilizing the conventional square-shaped window 701. Besides, on the peak signal-to-noise ratio of performing the noise attenuation, utilizing the diamond-shaped window 702 results in higher peak signal-to-noise ratios than utilizing the conventional square-shaped window 701 while the noise ratio of noises added in the images is less than 35%. However, when the noise ratio of noises added in the images is larger than 35%, utilizing the diamond-shaped window 702 may result in lower peak signal-to-noise ratios than utilizing the conventional square-shaped window 701. The phenomenon may be observed from FIG. 12. When the noise ratio of noises added in the images is higher than 40%, utilizing the diamond-shaped window 702 commonly results in lower peak signal-to-noise ratios than utilizing the conventional square-shaped window 701.

As can be observed from both FIG. 11 and FIG. 12, when the noise ratio of noises added into the images is increased, the peak signal-to-noise ratio in utilizing the diamond-shaped window is decreased faster than in utilizing the conventional square-shaped window. Therefore, when the noise ratio is higher than 35%, the peak signal-to-noise ratio in utilizing the diamond-shaped window may be lower than in utilizing the conventional square-shaped window. However, under ordinary circumstances, the noise ratio is not higher than 25%. Moreover, merely under an extremely severe circumstance, the noise ratio may be raised higher than 35%. Therefore, images having noises having a high noise ratio are not primary targets for the noise reduction method of the present invention.

Therefore, primary targets for the noise reduction method of the present invention are images having a standard noise ratio. In the noise reduction method of the present invention, filters of different types should be applied on images having different noise ratios as well, where the filters include a median filter, an alpha fine-tuning average filter, a harmonic average filter, and an arithmetic weighted average filter. In summary, the noise reduction method of the present invention utilizes a diamond-shaped window for decreasing a number of processed pixels, and thus reduces the execution time for attenuating noises. Therefore, benefits including raising the efficiency of noise attenuation, retarding the effects from edge pixels having low associations, and resulting in a lower peak signal-to-noise ratio, are thus achieved.

Note that the noise reduction method of the present invention is not limited to the abovementioned preferred embodiments of the present invention. In other words, conventional noise reduction methods utilizing a conventional square-shaped window will be improved by the diamond-shaped window disclosed in the noise reduction of the present invention. Therefore, any noise reduction methods utilizing the diamond-shaped window disclosed in the present invention should not be limitations to the noise reduction methods of the present invention.

Those skilled in the art will readily observe that numerous modifications and alterations of the device and method may be made while retaining the teachings of the invention.

What is claimed is:

1. A noise reduction method based on a diamond-shaped window enveloping a central pixel and a set of neighboring pixels, comprising:
shifting the diamond-shaped window to cover a first to-be-processed region on an image;
calculating an average value of a plurality of pixels on the covered first to-be-processed region;
arranging the plurality of pixels on the first to-be-processed region according to values of said plurality of pixels when a difference between the calculated average value and a value of the central pixel on the first to-be-processed region is larger than a predetermined value;
choosing a value of a pixel, which has a specific rank in the arranged plurality of pixels, as a filter's output; and
replacing the value of the central pixel on the first to-be-processed region with the first filter's output.

2. The noise reduction method of claim 1 wherein the set of neighboring pixels enveloped by the diamond-shaped window comprises four neighboring pixels located at the coordinates (1,0), (0,1), (−1,0), and (0,−1) as a first layer, wherein the central pixel is located at the coordinate (0,0) so that the first layer surrounds the central pixel.

3. The noise reduction of claim 1 wherein the set of neighboring pixels on the diamond-shaped window comprises four neighboring pixels located at the coordinates (0,1), (1,0), (−1,0), and (0,−1) as a first layer, four neighboring pixels located at the coordinates (1,1), (−1,1), (−1,−1), and (1,−1) as a second layer, and four neighboring pixels located at the coordinates (2,0), (0,2), (−2,0), and (0,−2) as a third layer, wherein the central pixel is located at the coordinate (0,0) so that all of the first layer, the second layer, and the third layer surround the central pixel.

4. The noise reduction method of claim 1 wherein the set of neighboring pixels on the diamond-shaped window comprises four neighboring pixels located at the coordinates (0,1), (1,0), (−1,0), and (0,−1) as a first layer, four neighboring pixels located at the coordinates (1,1), (−1,1), (−1,−1), and (1,−1) as a second layer, four neighboring pixels located at the coordinates (2,0), (0,2), (−2,0), and (0,−2) as a third layer, eight neighboring pixels located at the coordinates (2,1), (1,2), (−1,2), (−2,1), (−2,−1), (−1,−2), (1,−2), and (2,−1) as a fourth layer, and four neighboring pixels located at the coordinates (3,0), (0,3), (−3,0), and (0,−3) as a fifth layer, wherein the central pixel is located at the coordinate (0,0) so that all of the first layer, the second layer, the third layer, the fourth layer, and the fifth layer surround the central pixel.

5. The noise reduction method of claim 1 wherein when the covered first to-be-processed region is located at a corner of the image, the diamond-shaped window covers the image on an overlapped region; wherein calculating the average value of the plurality of pixels on the first to-be-processed region comprises calculating an average value of pixels on the overlapped region; wherein arranging the plurality of pixels on the first to-be-processed region according to values of the plurality of pixels when the difference between the calculated average value and the value of the central pixel on the first to-be-processed region is larger than the predetermined value comprises arranging the pixels on the overlapped region according to values of the pixels on the overlapped region.

6. The noise reduction method of claim 1 wherein when the covered first to-be-processed region is located at a border of the image, the diamond-shaped window covers the image on an overlapped region; wherein calculating the average value of the plurality of pixels on the first to-be-processed region comprises calculating an average value of pixels on the overlapped region; wherein arranging the plurality of pixels on the first to-be-processed region according to the values of the plurality of pixels when the difference between the calculated average value and the value of the central pixel on the first to-be-processed region is larger than the predetermined value comprises arranging the pixels on the overlapped region according to values of the pixels on the overlapped region.

7. The noise reduction method of claim 1 wherein choosing the value of the pixel having a specific rank in the arranged plurality of pixels as the first filter's output comprises:
choosing a value of a pixel having a median rank among the arranged plurality of pixels as the first filter's output.

8. The method of claim 1 wherein arranging the plurality of pixels on the first to-be-processed region according to the values of the plurality of pixels when the difference between the calculated average value and the value of the central pixel on the first to-be-processed region is larger than the predetermined value comprises:
processing each of the plurality of pixels on the first to-be-processed region with a weight, which is generated from a number of repeated times, wherein a pixel closer to the central pixel has a larger weight; and
arranging the plurality of processed pixels according to values of the plurality of processed pixels.

9. The noise reduction method of claim 1 further comprising:
shifting the diamond-shaped window to cover a second to-be-processed region on the image;
calculating an average value of a plurality of pixels on the covered second to-be-processed region;
arranging the plurality of pixels on the second to-be-processed region when a difference, which is between the calculated average value of the plurality of pixels on the second to-be-processed region and a value of a central pixel on said second to-be-processed region, is larger than the predetermined value;
choosing a value of a pixel having a specific rank in the arranged plurality of pixels of the second to-be-processed region as a second filter's output; and
replacing the value of the central pixel on the second to-be-processed region with the second filter's output.

10. The noise reduction method of claim 1 further comprising:
shifting the diamond-shaped window to cover a second to-be-processed region on the image;
calculating an average value of a plurality of pixels on the covered second to-be-processed region; and
preserving a value of a central pixel on the second to-be-processed region when a difference, which is between the calculated average value of the plurality of pixels on said second to-be-processed region and the value of the central pixel on said second to-be-processed region, is not larger than the predetermined value.

11. A noise reduction method based on a diamond-shaped window enveloping a central pixel and a set of neighboring pixels, the noise reduction method comprising:
shifting the diamond-shaped window to cover a first to-be-processed region on an image;
calculating an average value of a plurality of pixels on the covered first to-be-processed region; and
preserving a value of a central pixel on the first to-be-processed region when a difference between the calculated value and the value of the central pixel is not larger than a predetermined value.

12. The noise reduction method of claim 11 wherein the set of neighboring pixels enveloped by the diamond-shaped window comprises four neighboring pixels located at the coordinates (1,0), (0,1), (−1,0), and (0,−1) as a first layer, wherein the central pixel is located at the coordinate (0,0) so that the first layer surrounds the central pixel.

13. The noise reduction method of claim 11 wherein the set of neighboring pixels on the diamond-shaped window comprises four neighboring pixels located at the coordinates (0,1), (1,0), (−1,0), and (0,−1) as a first layer, four neighboring pixels located at the coordinates (1,1), (−1,1), (−1,−1), and (1,−1) as a second layer, and four neighboring pixels located at the coordinates (2,0), (0,2), (−2,0), and (0,−2) as a third layer, wherein the central pixel is located at the coordinate (0,0) so that all of the first layer, the second layer, and the third layer surround the central pixel.

14. The noise reduction method of claim 11 wherein the set of neighboring pixels on the diamond-shaped window comprises four neighboring pixels located at the coordinates (0,1), (1,0), (−1,0), and (0,−1) as a first layer, four neighboring pixels located at the coordinates (1,1), (−1,1), (−1,−1), and (1,−1) as a second layer, four neighboring pixels located at the coordinates (2,0), (0,2), (−2,0), and (0,−2) as a third layer, eight neighboring pixels located at the coordinates (2,1), (1,2), (−1,2), (−2,1), (−2,−1), (−1,−2), (1,−2), and (2,−1) as a fourth layer, and four neighboring pixels located at the coordinates (3,0), (0,3), (−3,0), and (0,−3) as a fifth layer, wherein the central pixel is located at the coordinate (0,0) so that all of the first layer, the second layer, the third layer, the fourth layer, and the fifth layer surround the central pixel.

15. The noise reduction method of claim 11 wherein when the covered first to-be-processed region is located at a corner of the image, the diamond-shaped window covers the image on an overlapped region; wherein calculating the average value of the plurality of pixels on the first to-be-processed region comprises calculating an average value of pixels on the overlapped region.

16. The noise reduction method of claim 11 wherein when the covered first to-be-processed region is located at a border of the image, the diamond-shaped window covers the image on an overlapped region; wherein calculating the average value of the plurality of pixels on the first to-be-processed region comprises calculating an average value of pixels on the overlapped region.

17. The noise reduction method of claim 11 further comprising:
shifting the diamond-shaped window to cover a second to-be-processed region on the image;
calculating an average value of a plurality of pixels on the covered second to-be-processed region;
arranging the plurality of pixels on the second to-be-processed region when a difference, which is between the calculated average value of the plurality of pixels on the second to-be-processed region and a value of a central pixel on said second to-be-processed region, is larger than the predetermined value;
choosing a value of a pixel having a specific rank in the arranged plurality of pixels of the second to-be-processed region as a second filter's output; and
replacing the value of the central pixel on the second to-be-processed region with the second filter's output.

18. The noise reduction method of claim 17 wherein choosing the value of the pixel having the specific rank in the arranged plurality of pixels of the second to-be-processed region as the second filter's output comprises:
choosing a pixel having an intermediate rank in the arranged plurality of pixels of the second to-be-processed region as the second filter's output.

19. The noise reduction method of claim 17 wherein arranging the plurality of pixels on the second to-be-processed region when the difference, which is between the calculated average value of the plurality of pixels on the second to-be-processed region and the value of the central pixel on the second to-be-processed region, is larger than the predetermined value comprises:
processing each of the plurality of pixels on the second to-be-processed region with a weight, which is generated from a number of repeated times, wherein a pixel closer to the central pixel has a larger weight; and
arranging the plurality of processed pixels according to values of the plurality of processed pixels.

20. The noise reduction of claim 11 further comprising:
shifting the diamond-shaped window to cover a second to-be-processed region on the image;
calculating an average value of a plurality of pixels on the covered second to-be-processed region; and
preserving a value of a central pixel on the second to-be-processed region when a difference, which is between the calculated average value of the plurality of pixels on said second to-be-processed region and the value of the central pixel on said second to-be-processed region, is not larger than the predetermined value.
